(19) United States
(12) Patent Application Publication
(10) Pub. No.: US 2026/0302587 A1
(43) Pub. Date: Oct. 1, 2026

(54) ANTENNA DEVICE AND BASE STATION DEVICE

(71) Applicant: NEC Corporation, Tokyo (JP)

(72) Inventors: Mahiro HACHIYA, Tokyo (JP); Yasuhiro KUBOTA, Tokyo (JP); Taro HIROSE, Tokyo (JP); Yoshihide TAKAHASHI, Tokyo (JP); Tsuyoshi SUKEGAWA, Tokyo (JP)

(73) Assignee: NEC Corporation, Tokyo (JP)

(21) Appl. No.: 19/565,790

(22) Filed: Mar. 13, 2026

(30) Foreign Application Priority Data
Mar. 26, 2025 (JP) 2025-052675

(51) Int. Cl. H01Q 1/00; H01Q 1/24; H01Q 1/42; H01Q 19/00

(52) U.S. Cl. CPC H01Q 1/002; H01Q 1/246; H01Q 1/42; H01Q 19/005

(57) ABSTRACT

An antenna device includes an electronic substrate having a surface on which an electronic circuit is formed, a plate member having a linear expansion coefficient different from that of the electronic substrate, a fixture that fixes the electronic substrate and the plate member, a feed antenna element provided on the electronic substrate, a parasitic antenna element provided on the plate member at a position facing the feed antenna element, and an inter-element distance adjustment mechanism that adjusts a distance between the feed antenna element and the parasitic antenna element.

### INCORPORATION BY REFERENCE

This application is based upon and claims the benefit of priority from Japanese patent application No. 2025-052675, filed on Mar. 26, 2025, the disclosure of which is incorporated herein in its entirety by reference.

### TECHNICAL FIELD

The present disclosure relates to an antenna device and a base station device.

### BACKGROUND ART

A base station device is a device that relays long-distance communication such as a mobile phone, and is mainly operated outdoors. At this time, if there is an obstacle between the base station device and a communication partner, radio waves are attenuated, which deteriorates communication stability. In view of the above, in order to avoid the attenuation of the radio waves, the base station device is often installed with a height difference from the communication partner. In that case, since a user as the communication partner is basically near the ground, the base station device is installed at a higher place. The base station device is often installed in an existing facility, such as a utility pole, a wall, or the like. Thus, it is desirable to make the base station device smaller and lighter from a viewpoint of installability and a load-bearing capacity.

In view of the above, US 2022/368028 A1 and U.S. Pat. No. 7,636,063 B2 are disclosed.

US 2022/368028 A1 discloses an antenna device in which a parasitic antenna element is provided on an inner surface of a radome. The parasitic antenna element and the radome are integrated to reduce the space between the parasitic antenna element and the radome in this manner, whereby a base station device is downsized. The radome is made of resin to make the base station device lighter.

U.S. Pat. No. 7,636,063 B2 also discloses an antenna device in which a parasitic antenna element is provided on an inner surface of a resin radome.

### SUMMARY

However, the antenna devices according to US 2022/368028 A1 and U.S. Pat. No. 7,636,063 B2 have a problem that an antenna gain deteriorates if the base station device is operated in a high-temperature environment and power consumption of the base station device increases to compensate for the antenna gain.

An example object of the present disclosure is to suppress antenna gain degradation caused by an increase in environmental temperature and to suppress an increase in power consumption accompanying the antenna gain degradation while maintaining sizes and weights of an antenna device and base station device.

An antenna device according to an example aspect of the present disclosure includes an electronic substrate having a surface on which an electronic circuit is formed, a plate member having a linear expansion coefficient different from that of the electronic substrate, a fixture that fixes the electronic substrate and the plate member, a feed antenna element provided on the electronic substrate, a parasitic antenna element provided on the plate member at a position facing the feed antenna element, and an inter-element distance adjustment mechanism that adjusts a distance between the feed antenna element and the parasitic antenna element.

According to an antenna device and a base station device according to the present disclosure, antenna gain degradation caused by an increase in environmental temperature may be suppressed while maintaining a size and weight, and an increase in power consumption may be suppressed.

### BRIEF DESCRIPTION OF THE DRAWINGS

FIG. 1 is a schematic cross-sectional view illustrating an example of a base station device;

FIG. 2 is cross-sectional views illustrating examples of an antenna device;

FIG. 3 is X-Y plane views illustrating examples of the antenna device;

FIG. 4 is a graph of a change amount of an inter-element distance with respect to a change amount of an environmental temperature;

FIG. 5 is a graph of a change amount of an antenna gain with respect to the change amount of the inter-element distance;

FIG. 6 is a schematic diagram illustrating a relationship between a change amount ΔL1 of the inter-element distance and an inter-fixing distance L2₁₂₀ on a side of a plate member 120 and an inter-fixing distance L2₂₅₀ on a side of an electronic substrate 250 at a time of operation of a base station device 1 in a high-temperature environment;

FIG. 7 is a graph illustrating a relationship between the change amount ΔL1 of the inter-element distance and a predetermined value L3 in a case where an increase amount ΔT of the environmental temperature is 28° C.;

FIG. 8 is a cross-sectional view illustrating an example of the antenna device;

FIG. 9 is a cross-sectional view illustrating an example of the antenna device;

FIG. 10 is a cross-sectional view illustrating an example of the antenna device;

FIG. 11 is a cross-sectional view illustrating an example of the antenna device;

FIG. 12 is cross-sectional views illustrating examples of the antenna device;

FIG. 13 is cross-sectional views illustrating examples of the antenna device; and

FIG. 14 is cross-sectional views illustrating examples of the antenna device.

### EXAMPLE EMBODIMENT

Hereinafter, specific example embodiments to which the present disclosure is applied will be described in detail with reference to the drawings. In the drawings, the same components are denoted by the same reference signs, and descriptions thereof will be omitted.

### First Example Embodiment

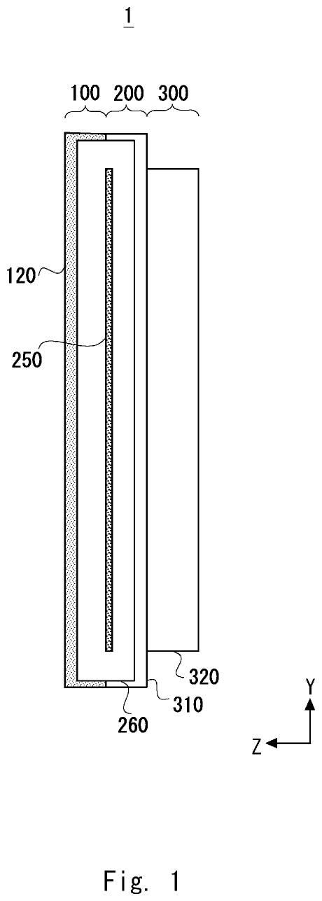

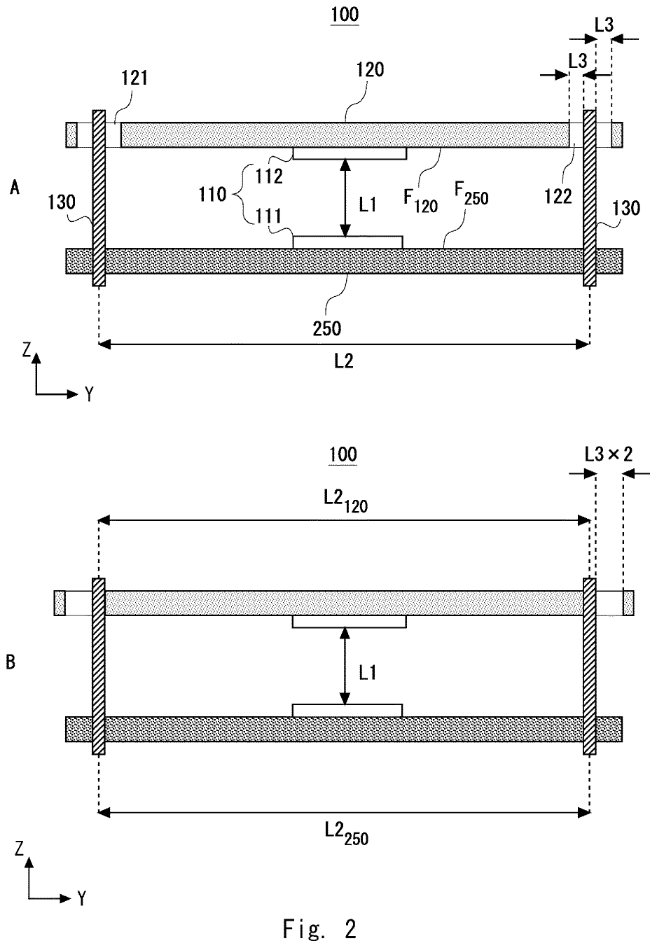

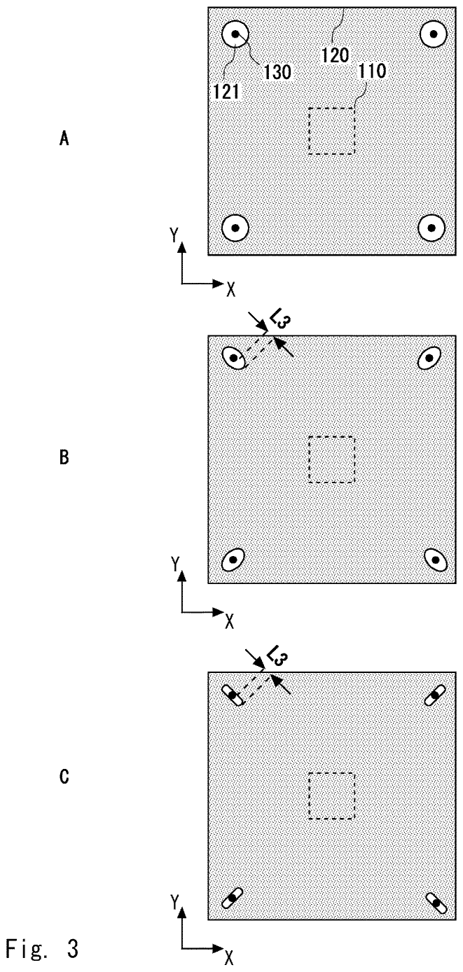

FIG. 1 is a schematic cross-sectional view illustrating an example of a base station device. FIG. 2 is cross-sectional views illustrating examples of an antenna device. FIG. 3 is X-Y plane views illustrating examples of the antenna device.

In FIG. 1, a base station device 1 includes an antenna device 100, an electronic substrate unit 200, and a heatsink 300.

In FIG. 2, the antenna device 100 includes an antenna element 110, a plate member 120, fixtures 130, and an electronic substrate 250.

In the electronic substrate unit 200, an electronic circuit is formed on a surface of the electronic substrate 250. For example, the electronic substrate unit 200 includes an electronic component (not illustrated) for performing signal processing, such as a field programmable gate array (FPGA), an electronic component (not illustrated) for performing noise processing, such as a band-pass filter (BPF), a power supply (not illustrated) for supplying power to the antenna element 110, connectors (not illustrated) for connecting to an external device, and a metal housing 260 for protecting those electronic components. The metal housing 260 may be manufactured by, for example, casting or cutting and processing an aluminum alloy. A gasket may be inserted between the metal housing 260 and the plate member 120 for waterproofing.

The heatsink 300 includes a base 310 and a plurality of heat dissipation fins 320. The base 310 is in contact with a heat source to receive heat. The heat dissipation fins 320 dissipate the heat of the heat source. Here, the heat source refers to a portion that generates heat at a time of operation of the base station device 1. For example, the heat source is an electronic component, such as an FPGA, mounted on the electronic substrate unit 200. The heatsink 300 may be manufactured by, for example, casting or cutting and processing an aluminum alloy.

The base 310 and the heat dissipation fin 320 may be integrated with each other, or may be separated from each other. The heatsink 300 and the metal housing 260 may be integrated with each other, or may be separated from each other. The heat source may be in direct contact with the base 310, or may be in indirect contact via a thermal interface material (TIM) or a thermal diffusion material such as a vapor chamber.

The antenna element 110 includes a feed antenna element 111 and a parasitic antenna element 112. For example, the antenna element 110 may be a plurality of patch antennas. The feed antenna element 111 and the parasitic antenna element 112 may include, for example, a copper-based alloy. The feed antenna element 111 is mounted on a main surface F₂₅₀ (X-Y plane) of the electronic substrate 250 facing the plate member 120. Then, the feed antenna element 111 is fed with power from the power supply via the electronic substrate 250.

The parasitic antenna element 112 is provided on a main surface F₁₂₀ (surface parallel to the X-Y plane) of the plate member 120 facing the electronic substrate 250. The parasitic antenna element 112 may be installed by, for example, adhesive bonding, plating, or hot stamping.

The feed antenna element 111 and the parasitic antenna element 112 may have their central axes overlapped with each other with a predetermined inter-element distance L1. A dielectric may be inserted between the feed antenna element 111 and the parasitic antenna element 112, and further between the plate member 120 and the electronic substrate 250. The dielectric may be, for example, a foam having a relative permittivity of approximately equal to 1.

The plate member 120 forms a radome. A material having a linear expansion coefficient different from that of the electronic substrate 250 is used for the plate member 120. For example, the plate member 120 is made of resin. Specifically, a vinyl resin may be subject to compression molding to form the plate member 120. The plate member 120 includes a hole 121 through which the fixture 130 passes. At a time of manufacturing the base station device 1, central axes of the hole 121 and fixture 130 overlap with each other as illustrated in A of FIG. 2. Here, a gap 122 having a predetermined value L3 is provided between the hole 121 and the fixture 130 as an inter-element distance adjustment mechanism. A strength reinforcing member may be inserted into the hole 121. The strength reinforcing member may be, for example, a thread insert or a collar. In that case, the predetermined value L3 is a difference between the inner diameter of the strength reinforcing member and the outer diameter of the fixture 130.

The fixture 130 is a jig for fixing the plate member 120 and the electronic substrate 250. A plurality of the fixtures 130 is provided with a predetermined inter-fixing distance L2. Here, the fixture 130 is perpendicular to the main surface F₁₂₀ of the plate member 120 and to the main surface F₂₅₀ of the electronic substrate 250. In other words, the fixture 130 is parallel to the Z-axis. For example, the fixture 130 may be a male screw. The plate member 120 and the electronic substrate 250 may be indirectly fixed via the metal housing 260.

As illustrated in FIG. 3, the hole 121 and the fixture 130 are provided at a plurality of positions surrounding the antenna element 110. The holes 121 and the fixtures 130 may be provided at the same intervals in the X-axis direction and the Y-axis direction. The holes 121 and the fixtures 130 may be provided at different intervals in the X-axis direction and the Y-axis direction.

As illustrated in A of FIG. 3, each of the holes 121 may be circular. Each of the holes 121 may have other shapes, such as an elliptical shape or an elongated hole shape, as illustrated in B and C of FIG. 3. In a case of a shape having a long diameter and a short diameter, such as an elliptical shape or an elongated hole shape, the long diameters are arranged radially, and the predetermined value L3 is a difference between the inner diameter of the hole 121 on the long-diameter side and the outer diameter of the fixture 130.

The antenna element 110 may have a square shape or another shape, such as a rectangular shape or a circular shape. The feed antenna element 111 and the parasitic antenna element 112 may have the same shape and size, or may have different shapes and sizes. One or a plurality of the antenna elements 110 may be provided between the adjacent fixtures 130. For example, the number of the antenna elements 110 arranged in the X-axis direction may be different from that in the Y-axis direction, such as two pieces in the X-axis direction×three pieces in the Y-axis direction, for a total of six pieces. A partition for isolation may be provided between the adjacent antenna elements 110. The partition may be integrated with the plate member 120, the metal housing 260, or the base 310. The partition may be separated from the plate member 120, the metal housing 260, or the base 310.

Next, functions of the antenna device 100 according to the first example embodiment will be described. First, a cause of antenna gain degradation will be described.

The electronic substrate 250 is commonly made of glass epoxy resin, and has a linear expansion coefficient of approximately 2×10⁻⁵° C.⁻¹. The metal housing 260 is commonly made of aluminum alloy, and also has a linear expansion coefficient of approximately 2×10⁻⁵° C.⁻¹. On the other hand, the plate member 120 is commonly made of vinyl resin, and has a linear expansion coefficient of approximately 10×10⁻⁵° C.⁻¹, which is about five times larger than that of the electronic substrate 250 or the metal housing 260.

The base station device 1 is commonly manufactured indoors at an environmental temperature of approximately 27° C., and in that state, the inter-element distance between the feed antenna element 111 and the parasitic antenna element 112 and the inter-fixing distance of the plate member 120 and electronic substrate 250 are set as design values.

Meanwhile, in requested specifications of the base station device 1, the upper limit of the environmental temperature at the time of operation is defined to be approximately 55° C. in consideration of outdoor installation. Thus, if the base station device 1 is operated in a high-temperature environment, an expansion amount of the plate member 120 is larger than that of the electronic substrate 250 or the metal housing 260, whereby the relatively softer plate member 120 bends outward from the base station device 1. As a result, the inter-element distance becomes wider than the design value, which deteriorates the antenna gain.

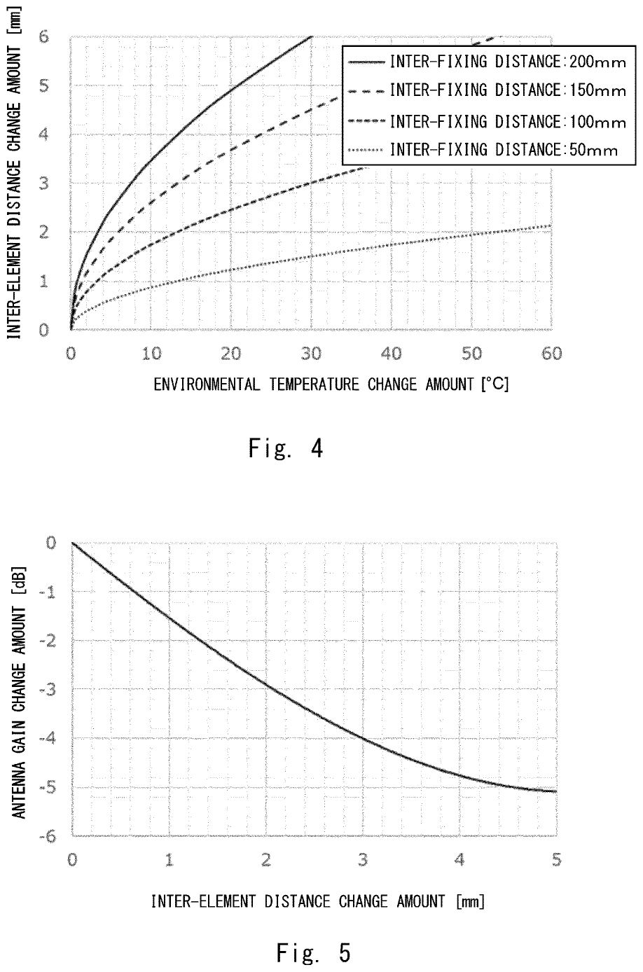

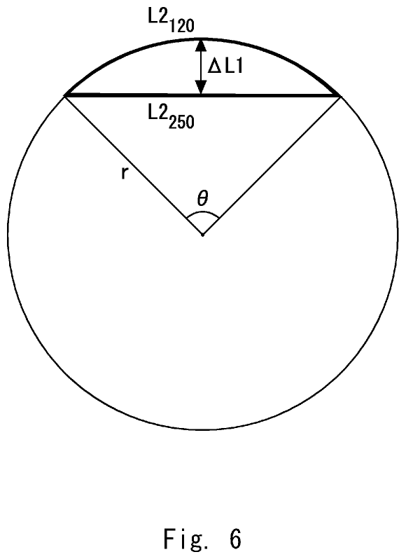

FIG. 4 illustrates a graph of a change amount of the inter-element distance with respect to a change amount of the environmental temperature. FIG. 5 illustrates a graph of a change amount of the antenna gain with respect to the change amount of the inter-element distance. In a case of the common base station device 1, the design value of the inter-fixing distance of the plate member 120 and electronic substrate 250 is approximately 150 mm. Thus, it can be seen that, if the base station device 1 manufactured at the environmental temperature of 27° C. is operated at the environmental temperature of 55° C., that is, if the environmental temperature rises by 28° C., the inter-element distance increases by 4.4 mm, and the antenna gain deteriorates by 4.9 dB.

Here, while the expansion amount of the plate member 120 is larger than that of the electronic substrate 250, since the antenna device 100 according to the first example embodiment is provided with the gap 122, a fixing position on the plate member 120 side (i.e., contact position between the plate member 120 and the fixture 130) shifts by the predetermined value L3 in a direction approaching the parasitic antenna element 112 in the X-Y plane direction, as illustrated in B of FIG. 2.

Specifically, in a case where an increase amount of the environmental temperature is assumed to be ΔT, the linear expansion coefficient of the plate member 120 is assumed to be α₁₂₀, and the linear expansion coefficient of the electronic substrate 250 is assumed to be α₂₅₀, an inter-fixing distance L2₁₂₀ on the plate member 120 side and an inter-fixing distance L2₂₅₀ on the electronic substrate 250 side at the time of the operation of the base station device 1 in the high-temperature environment may be simply expressed by the following equations (1) and (2).

L2₁₂₀=L2×(1+α₁₂₀×ΔT)−L3×2>L2₂₅₀>L2 (1)

L2₂₅₀=L2×(1+α₂₅₀×ΔT)>L2 (2)

FIG. 6 is a schematic diagram illustrating a relationship between a change amount ΔL1 of the inter-element distance and the inter-fixing distance L2₁₂₀ on the plate member 120 side and the inter-fixing distance L2₂₅₀ on the electronic substrate 250 side at the time of the operation of the base station device 1 in the high-temperature environment.

If the deflection of the plate member 120 is approximated with an arc, the change amount ΔL1 of the inter-element distance may be simply derived from simultaneous equations of the following equations (3), (4), and (5) in which a radius of the arc is denoted by r and a central angle is denoted by θ. The graph of FIG. 4 illustrates a solution in a case where L3 is zero.

ΔL1=r−r×Cos(θ=2) (3)

L2₁₂₀=r×θ (4)

L2₂₅₀=2×r×Sin(θ=2) (5)

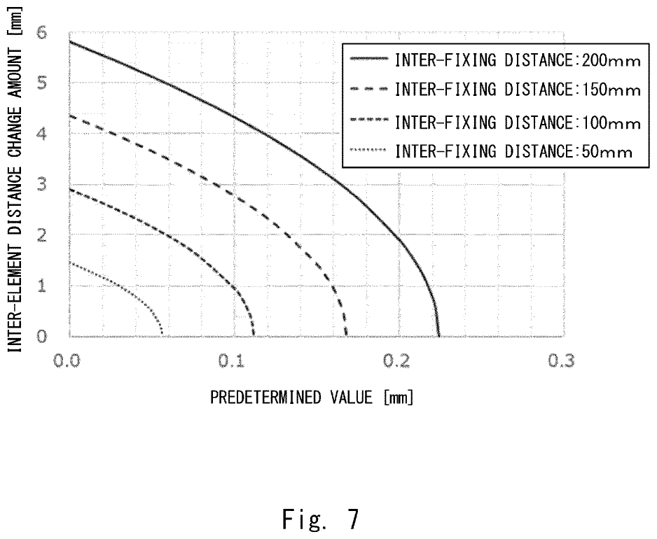

FIG. 7 is a graph illustrating a relationship between the change amount ΔL1 of the inter-element distance and the predetermined value L3 in the case where the increase amount ΔT of the environmental temperature is 28° C.

It can be seen that, the change amount ΔL1 of the inter-element distance may be reduced as the predetermined value L3 increases. It can also be seen that the antenna gain degradation may be suppressed in combination with FIG. 5. For example, if the increase amount ΔT of the environmental temperature is 28° C. and the inter-fixing distance L2 is 150 mm, setting the predetermined value L3 equal to or more than 0.164 mm makes the change amount ΔL1 of the inter-element distance and the antenna gain degradation zero. Here, the value of the predetermined value L3 is a value at which the inter-fixing distance L2₁₂₀ on the plate member 120 side is equal to the inter-fixing distance L2₂₅₀ on the electronic substrate 250 side.

As described above, according to the antenna device 100 according to the first example embodiment, the antenna gain degradation caused by an increase in the environmental temperature may be suppressed while maintaining the size and weight, and an increase in power consumption may be suppressed.

### Second Example Embodiment

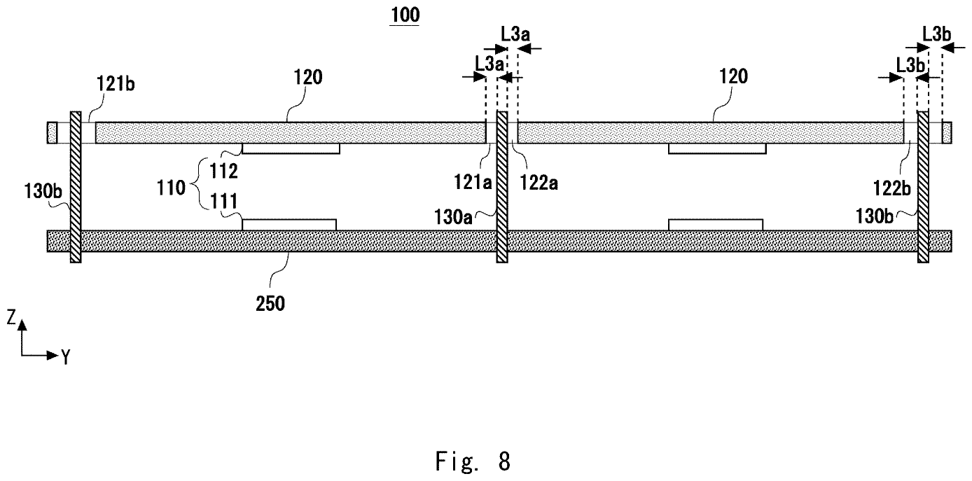

FIG. 8 is a cross-sectional view illustrating an example of an antenna device 100. In FIG. 8, the antenna device 100 includes an antenna element 110, a plate member 120, a fixture 130a on the center side, fixtures 130b on both sides, and an electronic substrate 250.

The plate member 120 has a hole 121a on the center side and holes 121b on both sides.

As illustrated in FIG. 8, in the case of arranging two antenna elements 110 and three fixtures 130 in the Y-axis direction, a gap 122b between the hole 121b on both sides and the fixture 130b is made larger than that in the first example embodiment by an amount of a gap 122a between the hole 121a on the center side and the fixture 130a made smaller than that in the first example embodiment.

In other words, a predetermined value L3a on the center side and a predetermined value L3b on both sides are set to different values within a range in which the sum of the predetermined value L3a and the predetermined value L3b on both sides satisfies a required value. As long as the condition described above is satisfied, for example, the predetermined value L3a on the center side may be set to zero, in other words, the gap 122a on the center side may be eliminated. Conversely, for example, the gap 122a on the center side may be made larger to eliminate the gap 122b on both sides.

A feed antenna element 111 and a parasitic antenna element 112, which serve as a pair and constitute each of the antenna elements 110, may have central axes overlapped with each other. However, an influence of a misalignment of the central axes on an antenna gain is smaller than an influence of a change in an inter-element distance. Thus, even if the gap 122 is offset, antenna gain degradation may be sufficiently suppressed.

According to the antenna device 100 according to the second example embodiment, the antenna gain degradation caused by an increase in environmental temperature may be suppressed while maintaining a size and weight, and an increase in power consumption may be suppressed. Since a restriction on the size of the hole 121 is made less stringent, designing is made easier in a case where, for example, stringent positioning requirements are set for a specific portion.

### Third Example Embodiment

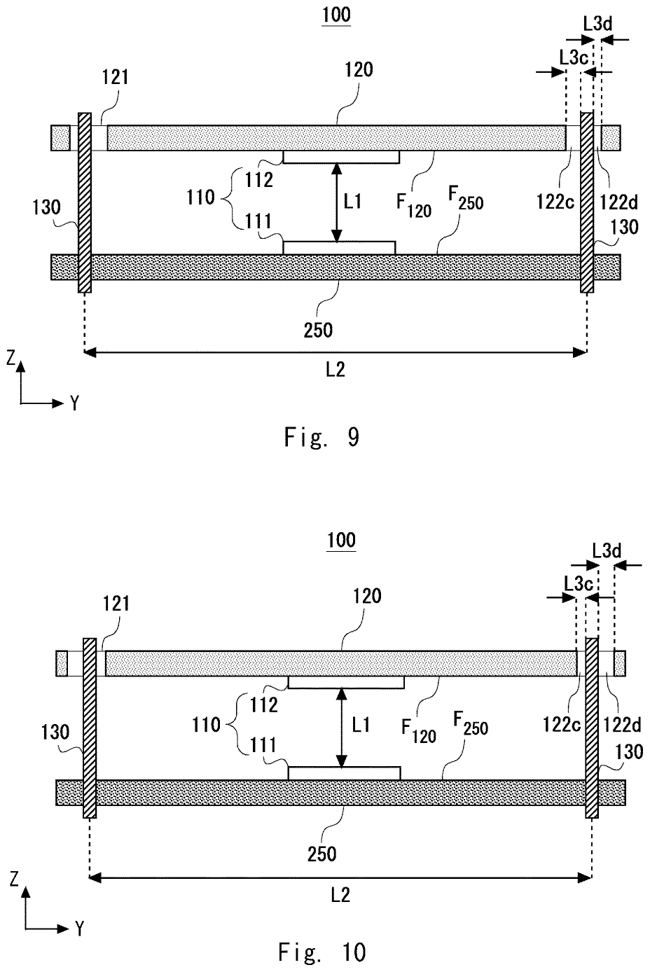

FIG. 9 is a cross-sectional view illustrating an example of an antenna device 100. As illustrated in FIG. 9, a hole 121 and a fixture 130 have central axes misaligned with each other, and a gap 122d farther than the fixture 130 as viewed from a parasitic antenna element 112 is made smaller than a nearer gap 122c. In other words, a predetermined value L3c on the nearer side is the same as that in the first example embodiment, whereas a predetermined value L3d on the farther side is made smaller than that in the first example embodiment.

If a base station device 1 is operated in a higher-temperature environment than at a time of manufacturing, antenna gain degradation occurs due to deflection of a plate member 120. In other words, this is in a case where a fixing position on the plate member 120 side needs to be shifted toward the parasitic antenna element 112 in the X-Y plane direction. That is, since the farther gap 122d does not contribute to an effect of suppressing the antenna gain degradation, it may be made smaller.

According to the antenna device according to the third example embodiment, the antenna gain degradation caused by an increase in environmental temperature may be suppressed while maintaining a size and weight, and an increase in power consumption may be suppressed. The hole 121 is made smaller, whereby rattling of the plate member 120 may be reduced.

### Fourth Example Embodiment

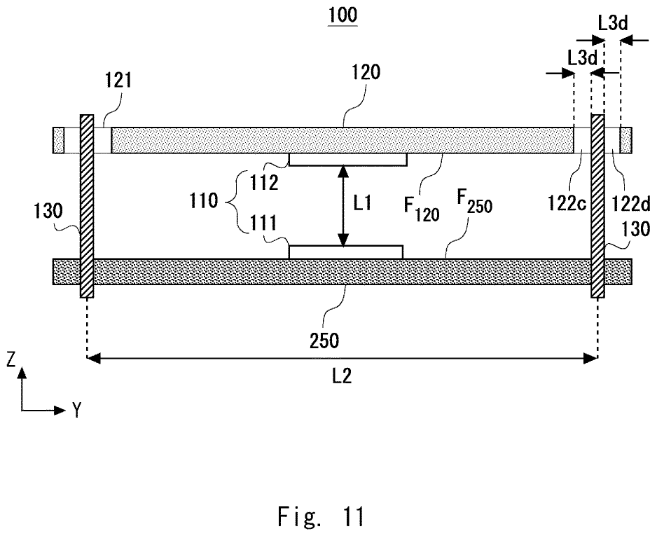

FIG. 10 is a cross-sectional view illustrating an example of an antenna device 100. As illustrated in FIG. 10, a hole 121 and a fixture 130 have central axes misaligned with each other, and a predetermined value L3c nearer than the fixture 130 as viewed from a center of a parasitic antenna element 112 is determined in consideration of an antenna gain degradation amount, and a farther predetermined value L3d is determined in consideration of a load applied to a plate member 120.

If a base station device 1 is operated in a lower-temperature environment than at a time of manufacturing, the plate member 120 has a contraction amount larger than that of an electronic substrate 250 or a metal housing 260. As a result, the relatively soft plate member 120 is stretched, which causes a problem that the plate member 120 is cracked starting from the contact portion between the hole 121 and the fixture 130 particularly at the hole 121 near the end portion of the plate member 120. In view of the above, a gap 122 is provided to shift a fixing position on the plate member 120 side away from the parasitic antenna element 112 in the X-Y plane direction, thereby reducing the load applied to the plate member 120.

Here, as described above, the gap 122 as a countermeasure against antenna gain degradation at a time of operation of the base station device 1 in a higher-temperature environment than at the time of manufacturing only needs to be disposed nearer than the fixture 130 as viewed from the parasitic antenna element 112. On the contrary, the gap 122 as a countermeasure against the cracking of the plate member 120 at the time of the operation in the lower-temperature environment than at the time of manufacturing only needs to be disposed farther than the fixture 130 as viewed from the parasitic antenna element 112. Thus, it is simultaneously established that the nearer predetermined value L3c is determined in consideration of the antenna gain degradation amount and the farther predetermined value L3d is determined in consideration of the load applied to the plate member 120.

According to the antenna device 100 according to the fourth example embodiment, the antenna gain degradation caused by an increase in environmental temperature may be suppressed while maintaining a size and weight, and an increase in power consumption may be suppressed. The cracking of the plate member 120 caused by a decrease in environmental temperature may also be suppressed.

### Fifth Example Embodiment

FIG. 11 is a cross-sectional view illustrating an example of an antenna device 100. As illustrated in FIG. 11, both nearer and farther gaps 122 are aligned to the larger one of a predetermined value L3c determined in consideration of antenna gain degradation and a predetermined value L3d determined in consideration of a load applied to a plate member 120.

FIG. 11 illustrates a case where the predetermined value L3d is larger than the predetermined value L3c. Here, as illustrated in FIG. 7, if a nearer gap 122c is made larger than the predetermined value L3c, an inter-element distance remains unchanged, and an effect of suppressing antenna gain degradation is not diminished.

According to the antenna device 100 according to the fifth example embodiment, the antenna gain degradation caused by an increase in environmental temperature may be suppressed while maintaining a size and weight, and an increase in power consumption may be suppressed. The cracking of the plate member 120 caused by a decrease in environmental temperature may also be suppressed. Furthermore, central axes of a hole 121 and a fixture 130 overlap with each other, which facilitates manufacturing.

### Sixth Example Embodiment

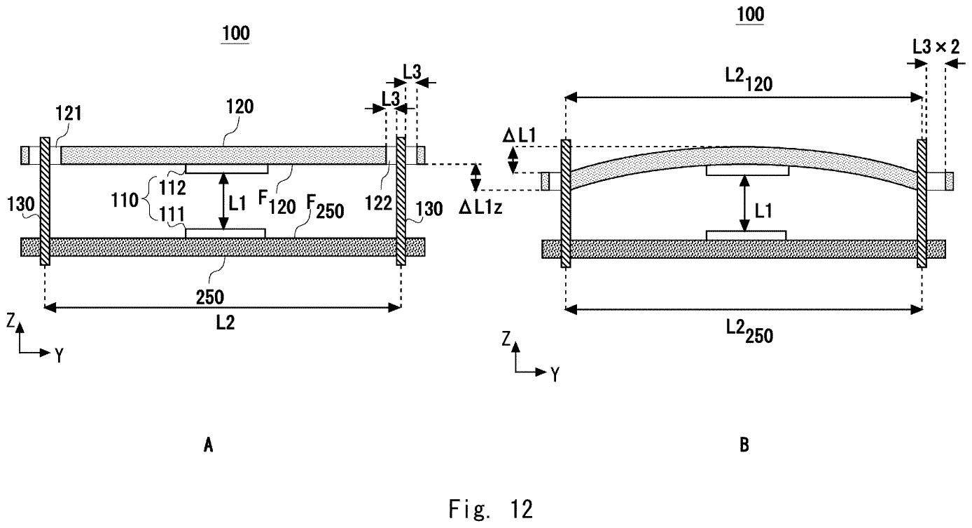

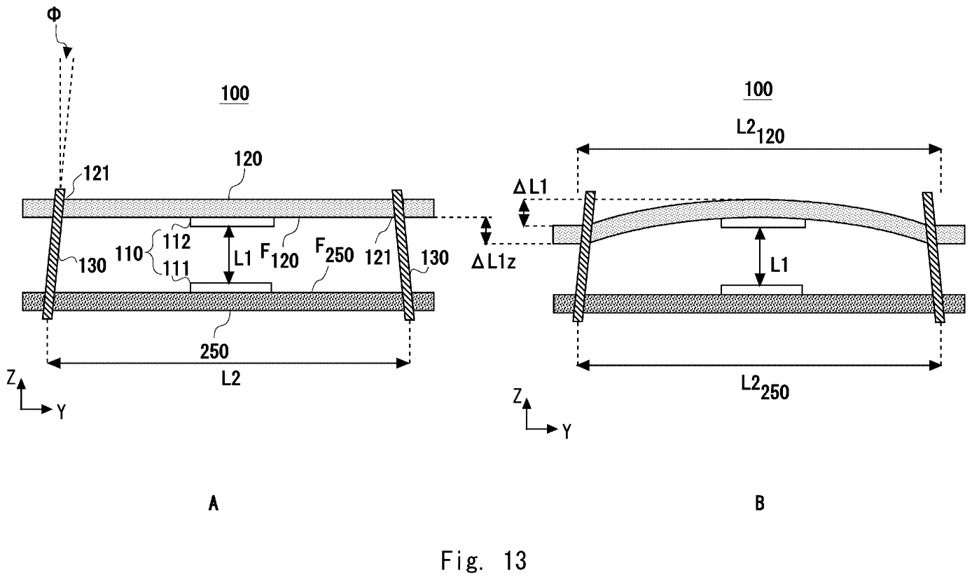

FIG. 12 is cross-sectional views illustrating examples of an antenna device 100. As illustrated in A of FIG. 12, at a time of manufacturing a base station device 1, a predetermined value L3 of a gap 122 is made smaller than that in the first example embodiment. Here, a fixture 130 is a male screw. A hole 121 is a female screw in an elongated slot shape (not illustrated).

If the base station device 1 is operated in a higher-temperature environment than at the time of manufacturing, both a plate member 120 and an electronic substrate 250 expand. At this time, since the plate member 120 has an expansion amount larger than that of the electronic substrate 250, as illustrated in B of FIG. 12, a fixing position on the plate member 120 side shifts by the predetermined value L3 toward a parasitic antenna element 112 in the X-Y plane direction due to the provision of the gap 122. Here, due to the action of the screw, the fixing position on the plate member 120 side simultaneously shifts by ΔL1z toward the electronic substrate 250 in the Z-axis direction.

A substantial change amount of an inter-element distance L1 may be reduced to ΔL1-ΔL1z. In other words, even if the predetermined value L3 is set to a value smaller than that in the first example embodiment, an effect of suppressing antenna gain degradation equivalent to that in the first example embodiment may be obtained.

According to the antenna device 100 according to the sixth example embodiment, the antenna gain degradation caused by an increase in environmental temperature may be suppressed while maintaining a size and weight, and an increase in power consumption may be suppressed. The hole 121 is made smaller, whereby rattling of the plate member 120 may be reduced.

### Seventh Example Embodiment

FIG. 13 is cross-sectional views illustrating examples of an antenna device 100. As illustrated in A of FIG. 13, as an inter-element distance adjustment mechanism, a fixture 130 is inclined at a predetermined angle φ with respect to the Z axis at a time of manufacturing a base station device 1, whereby an inter-fixing distance L2 is made narrower toward a plate member 120. A hole 121 is also inclined at the predetermined angle q with respect to the Z axis. In other words, the hole 121 and the fixture 130 are parallel to each other. No gap 122 is provided.

If the base station device 1 is operated in a higher-temperature environment than at the time of manufacturing, both a plate member 120 and an electronic substrate 250 expand. At this time, since the plate member 120 has an expansion amount larger than that of the electronic substrate 250, as illustrated in B of FIG. 13, a fixing position of the plate member 120 shifts by ALIz toward the electronic substrate 250 in the Z-axis direction due to the provision of the predetermined angle q.

A substantial change amount of an inter-element distance L1 may be reduced to ΔL1-ΔL1z. In other words, even if no gap 122 is provided, an effect of suppressing antenna gain degradation equivalent to that in the first example embodiment may be obtained.

According to the antenna device 100 according to the seventh example embodiment, the antenna gain degradation caused by an increase in environmental temperature may be suppressed while maintaining a size and weight, and an increase in power consumption may be suppressed. The hole 121 is made smaller, whereby rattling of the plate member 120 may be reduced.

### Eighth Example Embodiment

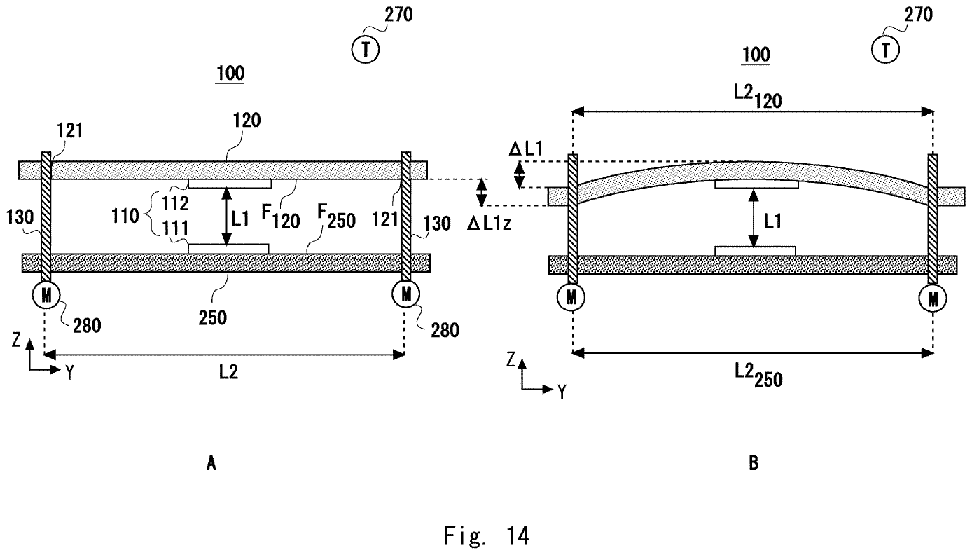

FIG. 14 is cross-sectional views illustrating examples of an antenna device 100. As illustrated in A of FIG. 14, at a time of manufacturing a base station device 1, the antenna device 100 further includes a mechanism 280 for rotating a fixture 130 as an inter-element distance adjustment mechanism. The mechanism 280 for rotating the fixture 130 may include an environmental temperature sensor 270.

The mechanism 280 for rotating the fixture 130 includes, for example, a motor and an integrated circuit, and may be powered by a power supply (not illustrated) via wiring (not illustrated). The environmental temperature sensor 270 may be connected to the mechanism 280 for rotating the fixture 130 via wiring (not illustrated), and an angle at which the fixture 130 is rotated may be determined depending on a measured environmental temperature. The environmental temperature sensor 270 may be, for example, a thermocouple.

A hole 121 is a female screw, the fixture 130 is a male screw, and no gap 122 is provided. While the hole 121 and the fixture 130 are parallel to the Z-axis, they may be oblique to the Z-axis in a similar manner to the seventh example embodiment.

While the mechanism 280 for rotating the fixture 130 is provided immediately adjacent to the fixture 130, the installation position is not limited to this. The mechanism 280 for rotating the fixture 130 may include a sensor for measuring an inter-element distance L1 instead of the environmental temperature sensor 270, or may include both. The mechanism 280 for rotating the fixture 130 may further include a mechanism for calculating an optimum fixing position on a side of a plate member 120 from a gain of the antenna device 100 or power consumption of the base station device 1.

If the base station device 1 is operated in a higher-temperature environment than at the time of manufacturing, both a plate member 120 and an electronic substrate 250 expand. At this time, the mechanism 280 for rotating the fixture 130 operates depending on a value measured by the environmental temperature sensor 270, whereby the fixing position on the plate member 120 side shifts by ΔL1z toward the electronic substrate 250 in the Z-axis direction due to the action of the screw, as illustrated in B of FIG. 14.

A substantial change amount of the inter-element distance L1 may be actively reduced to ΔL1-ΔL1z. In other words, even if no gap 122 is provided, an effect of suppressing antenna gain degradation equivalent to that in the first example embodiment may be actively obtained.

According to the antenna device 100 according to the eighth example embodiment, the antenna gain degradation caused by an increase in environmental temperature may be suppressed while maintaining a size and weight, and an increase in power consumption may be suppressed. The inter-element distance L1 is actively controlled, whereby the antenna gain degradation may be more reliably suppressed. Furthermore, the hole 121 is made smaller, whereby rattling of the plate member 120 may be reduced.

The present disclosure is not limited to the example embodiments described above, and may be appropriately modified without departing from the gist. For example, a plurality of the example embodiments may be combined.

Some or all of the above example embodiments may be described as, but are not limited to, the following Supplementary Notes.

### (Supplementary Note 1)

An antenna device including:
an electronic substrate;
a plate member having a linear expansion coefficient different from that of the electronic substrate;
a fixture for the electronic substrate and the plate member;
a feed antenna element provided on the electronic substrate;
a parasitic antenna element provided on the plate member at a position facing the feed antenna element; and
an inter-element distance adjustment mechanism for the feed antenna element and the parasitic antenna element.

### (Supplementary Note 2)

The antenna device according to Supplementary Note 1, in which the plate member includes resin, and the plate member is a radome or a part of the radome.

### (Supplementary Note 3)

The antenna device according to Supplementary Note 1, in which the feed antenna element and the parasitic antenna element include metal.

### (Supplementary Note 4)

The antenna device according to Supplementary Note 1, in which a method of providing the parasitic antenna element on the plate member is adhesive bonding, plating, or hot stamping.

### (Supplementary Note 5)

The antenna device according to Supplementary Note 1, in which the feed antenna element and the parasitic antenna element have a rangular shape or a circular shape.

### (Supplementary Note 6)

The antenna device according to Supplementary Note 1, in which the feed antenna element and the parasitic antenna element are different from each other in size, shape, or both.

### (Supplementary Note 7)

The antenna device according to Supplementary Note 1, in which a dielectric is inserted between the feed antenna element and the parasitic antenna element.

### (Supplementary Note 8)

The antenna device according to Supplementary Note 7, in which the dielectric includes a foam having a relative permittivity of approximately equal to 1.

### (Supplementary Note 9)

The antenna device according to Supplementary Note 1, in which a plurality of the antenna elements is arranged between the fixtures.

### (Supplementary Note 10)

The antenna device according to Supplementary Note 1, further including a partition for isolation between a plurality of the antenna elements.

### (Supplementary Note 11)

The antenna device according to Supplementary Note 1, in which the electronic substrate and the plate member are indirectly fixed via a metal housing.

### (Supplementary Note 12)

The antenna device according to Supplementary Note 1, in which the inter-element distance adjustment mechanism includes a gap provided between the fixture and a hole in the plate member for passing the fixture.

### (Supplementary Note 13)

The antenna device according to Supplementary Note 12, in which the hole has a circular shape, an elliptical shape, or an elongated hole shape.

### (Supplementary Note 14)

The antenna device according to Supplementary Note 12, in which the hole is arranged in such a way that a long diameter of the hole is arranged radially.

### (Supplementary Note 15)

The antenna device according to Supplementary Note 12, in which a strength reinforcing member is inserted into the hole.

### (Supplementary Note 16)

The antenna device according to Supplementary Note 15, in which the strength reinforcing member includes a thread insert or a collar.

### (Supplementary Note 17)

The antenna device according to Supplementary Note 12, in which a size of the gap is determined in consideration of an antenna gain change amount.

### (Supplementary Note 18)

The antenna device according to Supplementary Note 17, in which the size of the gap is determined also in consideration of a load applied to the plate member.

### (Supplementary Note 19)

The antenna device according to Supplementary Note 12, in which the gap is provided at a position nearer than the fixture as viewed from the parasitic antenna element.

### (Supplementary Note 20)

The antenna device according to Supplementary Note 19, in which the gap is also provided at a position farther than the fixture as viewed from the parasitic antenna element.

### (Supplementary Note 21)

The antenna device according to Supplementary Note 12, in which the gap is provided both at positions nearer and farther than the fixture as viewed from the parasitic antenna element, and a size of the gap is set to a larger value of a value determined in consideration of an antenna gain change amount and a value determined in consideration of a load applied to the plate member.

### (Supplementary Note 22)

The antenna device according to Supplementary Note 1, in which the inter-element distance adjustment mechanism includes a hole in the plate member for passing the fixture and a screw structure provided in the fixture.

### (Supplementary Note 23)

The antenna device according to Supplementary Note 1, in which the inter-element distance adjustment mechanism includes an inclination angle of the fixture with respect to the plate member.

### (Supplementary Note 24)

The antenna device according to Supplementary Note 1, in which the inter-element distance adjustment mechanism includes a mechanism that rotates the fixture.

### (Supplementary Note 25)

The antenna device according to Supplementary Note 24, in which the mechanism that rotates the fixture includes a motor and an integrated circuit.

### (Supplementary Note 26)

The antenna device according to Supplementary Note 24, in which the mechanism that rotates the fixture includes a sensor that determines an angle at which the fixture is rotated.

### (Supplementary Note 27)

The antenna device according to Supplementary Note 26, in which the sensor measures an environmental temperature.

### (Supplementary Note 28)

The antenna device according to Supplementary Note 26, in which the sensor measures the inter-element distance.

### (Supplementary Note 29)

A base station device including the antenna device according to Supplementary Note 1.

### (Supplementary Note 30)

An antenna device including:
an electronic substrate having a surface on which an electronic circuit is formed;
a plate member having a linear expansion coefficient different from that of the electronic substrate;
a fixture that fixes the electronic substrate and the plate member;
a feed antenna element provided on the electronic substrate;
a parasitic antenna element provided on the plate member at a position facing the feed antenna element; and
an inter-element distance adjustment mechanism that adjusts a distance between the feed antenna element and the parasitic antenna element.

### (Supplementary Note 31)

The antenna device according to Supplementary Note 30, in which the plate member includes resin, and the plate member is at least a part of a radome.

### (Supplementary Note 32)

The antenna device according to Supplementary Note 30, in which
the inter-element distance adjustment mechanism includes a gap between the fixture and a hole in the plate member for passing the fixture, and
the gap exists in a state where the fixture is inserted into the hole.

### (Supplementary Note 33)

The antenna device according to Supplementary Note 32, in which
the hole has an elliptical shape or an elongated hole shape, and
a long diameter of the hole is arranged radially.

### (Supplementary Note 34)

The antenna device according to Supplementary Note 32, in which the gap is provided at a position nearer than the fixture as viewed from a center of the parasitic antenna element.

### (Supplementary Note 35)

The antenna device according to Supplementary Note 34, in which the gap is also provided at a position farther than the fixture as viewed from the center of the parasitic antenna element.

### (Supplementary Note 36)

The antenna device according to Supplementary Note 32, in which
the gap is provided both at a position nearer than the fixture and at a position farther than the fixture as viewed from a center of the parasitic antenna element, and
a size of the gap is set to a larger value of a value determined in consideration of an antenna gain change amount and a value determined in consideration of a load applied to the plate member.

### (Supplementary Note 37)

The antenna device according to Supplementary Note 30, in which the inter-element distance adjustment mechanism includes an inclination angle of the fixture with respect to the plate member.

### (Supplementary Note 38)

The antenna device according to Supplementary Note 30, in which the inter-element distance adjustment mechanism includes a mechanism that rotates the fixture.

### (Supplementary Note 39)

A base station device including the antenna device according to any one of Supplementary Notes 30 to 38.

Some or all of the elements (e.g., configurations and functions) described in Supplementary Notes 2 to 28 dependent on Supplementary Note 1 may also be dependent on Supplementary Note 29 with dependency relationships similar to those of Supplementary Notes 2 to 28. Some or all of the elements (e.g., configurations and functions) described in Supplementary Notes 31 to 38 dependent on Supplementary Note 30 may also be dependent on Supplementary Note 39 with dependency relationships similar to those of Supplementary Notes 31 to 38. Some or all of the elements described in any Supplementary Note may be applied to various methods.

1. An antenna device comprising:
an electronic substrate having a surface on which an electronic circuit is formed;
a plate member having a linear expansion coefficient different from the linear expansion coefficient of the electronic substrate;
a fixture that fixes the electronic substrate and the plate member;
a feed antenna element provided on the electronic substrate;
a parasitic antenna element provided on the plate member at a position facing the feed antenna element; and
an inter-element distance adjustment mechanism that adjusts a distance between the feed antenna element and the parasitic antenna element.

2. The antenna device according to claim 1, wherein the plate member includes resin, and the plate member is at least a part of a radome.

3. The antenna device according to claim 1, wherein
the inter-element distance adjustment mechanism includes a gap between the fixture and a hole in the plate member for passing the fixture, and
the gap exists in a state where the fixture is inserted into the hole.

4. The antenna device according to claim 3, wherein
the hole has an elliptical shape or an elongated hole shape, and
a long diameter of the hole is arranged radially.

5. The antenna device according to claim 3, wherein the gap is provided at a position nearer than the fixture as viewed from a center of the parasitic antenna element.

6. The antenna device according to claim 5, wherein the gap is also provided at a position farther than the fixture as viewed from the center of the parasitic antenna element.

7. The antenna device according to claim 3, wherein
the gap is provided both at a position nearer than the fixture and at a position farther than the fixture as viewed from a center of the parasitic antenna element, and
a size of the gap is set to a larger value of a value determined in consideration of an antenna gain change amount and a value determined in consideration of a load applied to the plate member.

8. The antenna device according to claim 1, wherein the inter-element distance adjustment mechanism includes an inclination angle of the fixture with respect to the plate member.

9. The antenna device according to claim 1, wherein the inter-element distance adjustment mechanism includes a mechanism that rotates the fixture.

10. A base station device comprising the antenna device according to claim 1.
